(19) United States
(12) Patent Application Publication
(10) Pub. No.: US 2015/0214843 A1
(43) Pub. Date: Jul. 30, 2015

(54) REBOOST POWER CONVERSION APPARATUS HAVING FLYBACK MODE

(71) Applicant: Chicony Power Technology Co., Ltd., New Taipei City (TW)

(72) Inventors: Chu-Chen YANG, New Taipei City (TW); Chao-Jui HUANG, New Taipei City (TW)

(73) Assignee: Chicony Power Technology Co., Ltd., New Taipei City (TW)

(21) Appl. No.: 14/166,738

(22) Filed: Jan. 28, 2014

(51) Int. Cl. H02M 3/335; H02M 1/08; H02J 7/00

(52) U.S. Cl. CPC H02M 3/33507; H02J 7/0072; H02M 1/08; H02M 2001/0003

(57) ABSTRACT

A reboost power conversion apparatus (10) having a flyback mode includes a transformer (108), a primary side switch unit (110), a primary side switch control unit (112), a first unidirectional conduction unit (114), a first electric charge storage unit (116), a second electric charge storage unit (118), a second unidirectional conduction unit (120), a mode change-over switch unit (122) and a mode change-over switch control unit (124). The reboost power conversion apparatus (10) has functions of a reboost power conversion apparatus when the mode change-over switch control unit (124) is configured to turn on the mode change-over switch unit (122). The reboost power conversion apparatus (10) has functions of a flyback power conversion apparatus when the mode change-over switch control unit (124) is configured to turn off the mode change-over switch unit (122).

### BACKGROUND OF THE INVENTION

1. Field of the Invention

The present invention relates to a reboost power conversion apparatus, and especially relates to a reboost power conversion apparatus having a flyback mode.

2. Description of the Related Art

The reboost power conversion apparatus has the advantages of high efficiency and high voltage boost ratio. Therefore, the reboost power conversion apparatus is used widely.

FIG. 1 shows a waveform diagram of an embodiment of an output voltage of a conventional reboost power conversion apparatus. The disadvantage of the reboost power conversion apparatus is that the lowest output voltage of the reboost power conversion apparatus will be clamped by the input voltage (the horizontal line of the waveform). The lowest output voltage of the reboost power conversion apparatus cannot be zero if the input voltage is not zero, as shown in FIG. 1.

Therefore, the conventional reboost power conversion apparatus can be used as a boost inverter only. The conventional reboost power conversion apparatus cannot be applied to a power supply which outputs an alternating current power, for example, a micro inverter. FIG. 2 shows a waveform diagram of an embodiment of an output voltage of a power conversion apparatus which is applicable to a power supply outputting an alternating current power. FIG. 3 shows a waveform diagram showing that the output voltage shown in FIG. 2 is inverted. The output voltage (as shown in FIG. 1) of the conventional reboost power conversion apparatus cannot be the perfect zero-crossing (as shown in FIG. 3) after inverting. Therefore, the conventional reboost power conversion apparatus cannot be applied to the power supply which outputs the alternating current power.

### SUMMARY OF THE INVENTION

In order to solve the above-mentioned problems, an object of the present invention is to provide a reboost power conversion apparatus having a flyback mode.

In order to achieve the object of the present invention mentioned above, the reboost power conversion apparatus includes a power input side, a power output side, a power negative side, a transformer, a primary side switch unit, a primary side switch control unit, a first unidirectional conduction unit, a first electric charge storage unit, a second electric charge storage unit, a second unidirectional conduction unit, a mode change-over switch unit and a mode change-over switch control unit. The transformer is electrically connected to the power input side. The primary side switch unit is electrically connected to the transformer and the power negative side. The primary side switch control unit is electrically connected to the primary side switch unit. The first unidirectional conduction unit is electrically connected to the transformer and the power output side. The first electric charge storage unit is electrically connected to the transformer and the power output side. The second electric charge storage unit is electrically connected to the transformer, the first electric charge storage unit and the power negative side. The second unidirectional conduction unit is electrically connected to the transformer and the primary side switch unit. The mode change-over switch unit is electrically connected to the second unidirectional conduction unit, the transformer, the first electric charge storage unit and the second electric charge storage unit. The mode change-over switch control unit is electrically connected to the mode change-over switch unit. The reboost power conversion apparatus has functions of a reboost power conversion apparatus when the mode change-over switch control unit is configured to turn on the mode change-over switch unit. The reboost power conversion apparatus has functions of a flyback power conversion apparatus when the mode change-over switch control unit is configured to turn off the mode change-over switch unit.

The efficiency of the present invention is that the lowest output voltage of the reboost power conversion apparatus can be zero, so that the reboost power conversion apparatus can be applied to the power supply which outputs the alternating current power.

### BRIEF DESCRIPTION OF DRAWING

FIG. 1 shows a waveform diagram of an embodiment of an output voltage of a conventional reboost power conversion apparatus.

FIG. 2 shows a waveform diagram of an embodiment of an output voltage of a power conversion apparatus which is applicable to a power supply outputting an alternating current power.

FIG. 3 shows a waveform diagram showing that the output voltage shown in FIG. 2 is inverted.

FIG. 4 shows a block diagram of the first embodiment of the reboost power conversion apparatus of the present invention.

FIG. 5 shows a block diagram of the second embodiment of the reboost power conversion apparatus of the present invention.

FIG. 6 shows a block diagram of the third embodiment of the reboost power conversion apparatus of the present invention.

FIG. 7 shows a block diagram of the fourth embodiment of the reboost power conversion apparatus of the present invention.

### DETAILED DESCRIPTION OF THE INVENTION

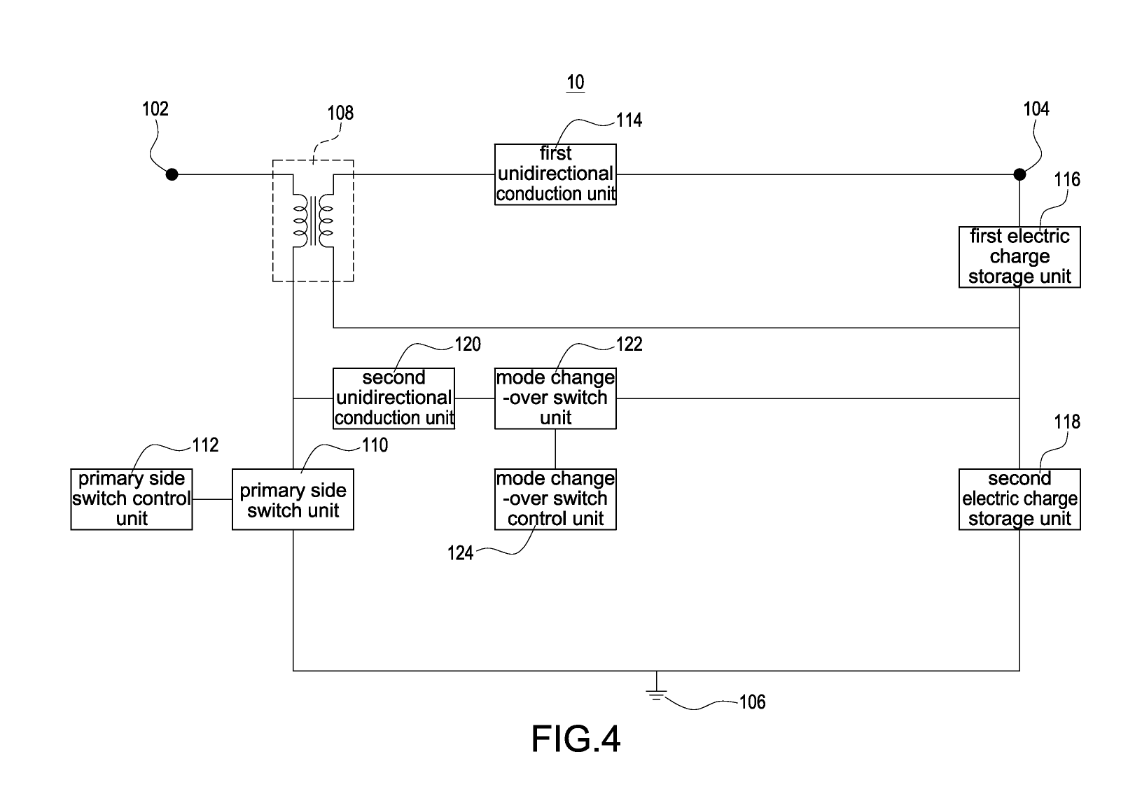

FIG. 4 shows a block diagram of the first embodiment of the reboost power conversion apparatus of the present invention. A reboost power conversion apparatus 10 having a flyback mode includes a power input side 102, a power output side 104, a power negative side 106, a transformer 108, a primary side switch unit 110, a primary side switch control unit 112, a first unidirectional conduction unit 114, a first electric charge storage unit 116, a second electric charge storage unit 118, a second unidirectional conduction unit 120, a mode change-over switch unit 122 and a mode change-over switch control unit 124.

The primary side switch unit 110 is, for example but not limited to, a transistor switch. The first unidirectional conduction unit 114 is, for example but not limited to, a diode, wherein a cathode of the diode is electrically connected to the power output side 104 and an anode of the diode is electrically connected to the transformer 108. The first electric charge storage unit 116 is, for example but not limited to, a capacitor. The second electric charge storage unit 118 is, for example but not limited to, a capacitor. The second unidirectional conduction unit 120 is, for example but not limited to, a diode, wherein a cathode of the diode is electrically connected to the mode change-over switch unit 122 and an anode of the diode is electrically connected to the transformer 108. The mode change-over switch unit 122 is, for example but not limited to, a transistor switch.

The transformer 108 is electrically connected to the power input side 102. The primary side switch unit 110 is electrically connected to the transformer 108 and the power negative side 106. The primary side switch control unit 112 is electrically connected to the primary side switch unit 110. The first unidirectional conduction unit 114 is electrically connected to the transformer 108 and the power output side 104. The first electric charge storage unit 116 is electrically connected to the transformer 108 and the power output side 104. The second electric charge storage unit 118 is electrically connected to the transformer 108, the first electric charge storage unit 116 and the power negative side 106. The second unidirectional conduction unit 120 is electrically connected to the transformer 108 and the primary side switch unit 110. The mode change-over switch unit 122 is electrically connected to the second unidirectional conduction unit 120, the transformer 108, the first electric charge storage unit 116 and the second electric charge storage unit 118. The mode change-over switch control unit 124 is electrically connected to the mode change-over switch unit 122.

The reboost power conversion apparatus 10 has functions of a reboost power conversion apparatus when the mode change-over switch control unit 124 is configured to turn on the mode change-over switch unit 122. The reboost power conversion apparatus 10 has functions of a flyback power conversion apparatus when the mode change-over switch control unit 124 is configured to turn off the mode change-over switch unit 122.

The mode change-over switch control unit 124 is configured to turn off the mode change-over switch unit 122 when the lowest output voltage of the reboost power conversion apparatus 10 is clamped by an input voltage (not shown in FIG. 4, sent through the power input side 102). Therefore, the reboost power conversion apparatus 10 becomes a flyback power converter to overcome this problem. The mode change-over switch control unit 124 is configured to turn on the mode change-over switch unit 122 when the lowest output voltage of the reboost power conversion apparatus 10 is not clamped by the input voltage. Therefore, the reboost power conversion apparatus 10 becomes a reboost power converter.

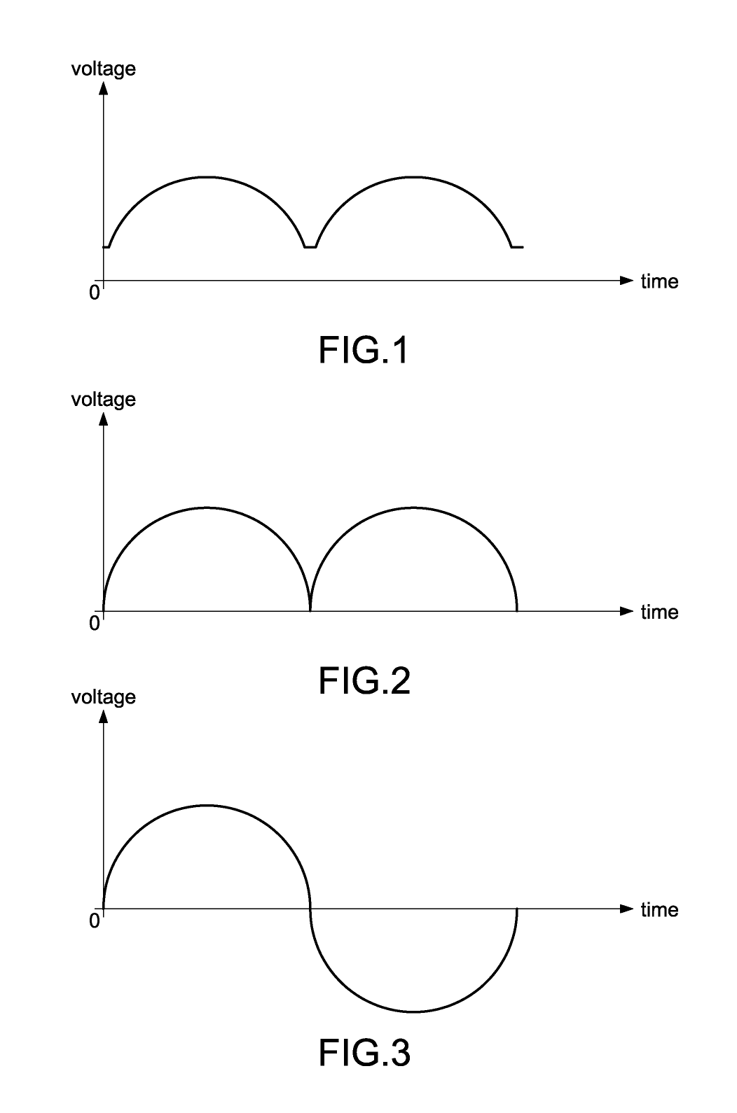

Therefore, a waveform of an output voltage (not shown in FIG. 4, outputted from the power output side 104) of the reboost power conversion apparatus 10 will be the same as the waveform shown in FIG. 2, which is different from FIG. 1. The reboost power conversion apparatus 10 can be applied to a power supply (not shown in FIG. 4) which outputs an alternating current power.

In another word, the reboost power conversion apparatus 10 becomes a flyback power converter when the lowest output voltage of the reboost power conversion apparatus 10 is clamped by the input voltage. Therefore, the output voltage of the reboost power conversion apparatus 10 can be smaller than the input voltage. The lowest output voltage of the reboost power conversion apparatus 10 can be zero.

In an embodiment, the mode change-over switch control unit 124 is configured to turn off the mode change-over switch unit 122 once every half of a period of the output voltage if the output voltage is an alternating current power (sine wave), so that the reboost power conversion apparatus 10 becomes a flyback power converter. The mode change-over switch control unit 124 is configured to turn on the mode change-over switch unit 122 in the rest of the time, so that the reboost power conversion apparatus 10 becomes a reboost power converter. For example, the mode change-over switch control unit 124 is configured to turn off the mode change-over switch unit 122 once every 1/120 second if the period of the alternating current power is 1/60 second.

In another embodiment, the reboost power conversion apparatus 10 further includes a power input side voltage detector (not shown in FIG. 4) and a power output side voltage detector (not shown in FIG. 4). The power input side voltage detector is electrically connected to the power input side 102 and the mode change-over switch control unit 124. The power output side voltage detector is electrically connected to the power output side 104 and the mode change-over switch control unit 124. The power input side voltage detector detects a voltage of the power input side 102 and then informs the mode change-over switch control unit 124. The power output side voltage detector detects a voltage of the power output side 104 and then informs the mode change-over switch control unit 124.

The mode change-over switch control unit 124 is configured to turn on the mode change-over switch unit 122 when an absolute target value of the output voltage is larger than an absolute value of the input voltage, so that the reboost power conversion apparatus 10 becomes a reboost power converter. The mode change-over switch control unit 124 is configured to turn off the mode change-over switch unit 122 when the absolute target value of the output voltage is not larger than the absolute value of the input voltage, so that the reboost power conversion apparatus 10 becomes a flyback power converter.

Moreover, the reboost power conversion apparatus 10 can be applied to an alternating current inverter circuit (for example, a full bridge circuit) connected to the power input side 102 or the power output side 104. Therefore, the reboost power conversion apparatus 10 can be applied to a direct current to direct current area, a direct current to alternating current area (for example, a micro inverter), an alternating current to direct current area or an alternating current to alternating current area. The primary side switch control unit 112 is configured to control the primary side switch unit 110 by pulse width modulation (for examples, DCM, CCM, BCM or QR mode) signals.

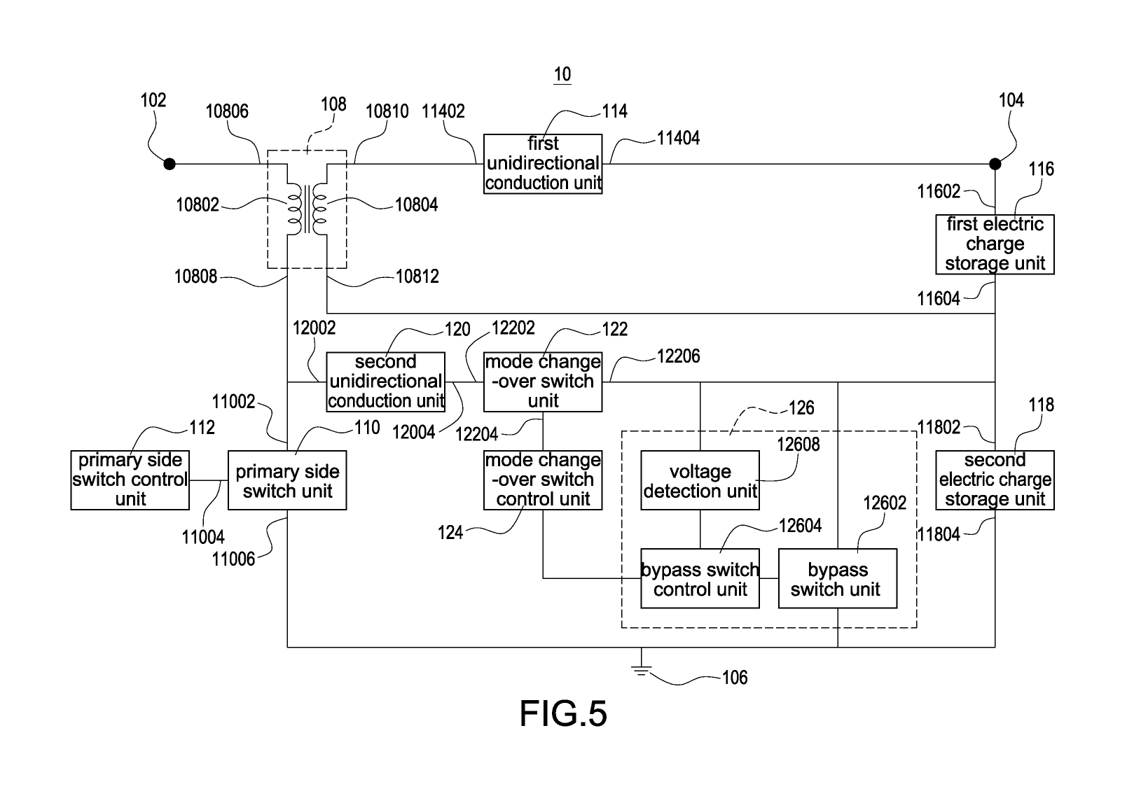

FIG. 5 shows a block diagram of the second embodiment of the reboost power conversion apparatus of the present invention. The description for the elements shown in FIG. 5, which are similar to those shown in FIG. 4, is not repeated here for brevity. Moreover, the reboost power conversion apparatus 10 further includes a second electric charge storage bypass circuit 126. The second electric charge storage bypass circuit 126 is electrically connected to the transformer 108, the first electric charge storage unit 116, the second electric charge storage unit 118, the mode change-over switch unit 122 and the power negative side 106.

The second electric charge storage unit 118 will discharge electricity to the power negative side 106 correctly according to the second electric charge storage bypass circuit 126 when the mode change-over switch control unit 124 is configured to turn off the mode change-over switch unit 122.

In another word, the second electric charge storage bypass circuit 126 provides the second electric charge storage unit 118 a bypass path when the reboost power conversion apparatus 10 is a flyback power converter. Therefore, a voltage of the second electric charge storage unit 118 is zero. The second electric charge storage unit 118 does not receive a negative charging current, so that the voltage of the second electric charge storage unit 118 is not negative.

The second electric charge storage bypass circuit 126 includes a bypass switch unit 12602, a bypass switch control unit 12604 and a voltage detection unit 12608. The bypass switch unit 12602 is electrically connected to the transformer 108, the first electric charge storage unit 116, the second electric charge storage unit 118, the mode change-over switch unit 122 and the power negative side 106. The bypass switch control unit 12604 is electrically connected to the bypass switch unit 12602 and the mode change-over switch control unit 124. The voltage detection unit 12608 is electrically connected to the transformer 108, the first electric charge storage unit 116, the second electric charge storage unit 118, the mode change-over switch unit 122, the bypass switch unit 12602 and the bypass switch control unit 12604. The bypass switch unit 12602 is, for example but not limited to, a transistor switch.

The mode change-over switch control unit 124 informs the bypass switch control unit 12604 when the reboost power conversion apparatus 10 is a flyback power converter. The voltage detection unit 12608 detects the voltage of the second electric charge storage unit 118 and then informs the bypass switch control unit 12604. The bypass switch control unit 12604 is configured to turn on or turn off the bypass switch unit 12602 according to the voltage of the second electric charge storage unit 118.

The mode change-over switch control unit 124 informs the bypass switch control unit 12604 when the reboost power conversion apparatus 10 is a reboost power converter. The bypass switch control unit 12604 is configured to turn off the bypass switch unit 12602.

The transformer 108 includes a transformer primary side 10802 and a transformer secondary side 10804. The transformer primary side 10802 is electrically connected to the power input side 102. The transformer secondary side 10804 is arranged in accordance with the transformer primary side 10802. The transformer primary side 10802 includes a transformer first pin 10806 and a transformer second pin 10808. The transformer first pin 10806 is electrically connected to the power input side 102. The transformer secondary side 10804 includes a transformer third pin 10810 and a transformer fourth pin 10812.

The primary side switch unit 110 includes a primary side switch first pin 11002, a primary side switch second pin 11004 and a primary side switch third pin 11006. The primary side switch first pin 11002 is electrically connected to the transformer second pin 10808. The primary side switch second pin 11004 is electrically connected to the primary side switch control unit 112. The primary side switch third pin 11006 is electrically connected to the power negative side 106.

The first unidirectional conduction unit 114 includes a first unidirectional conduction first pin 11402 and a first unidirectional conduction second pin 11404. The first unidirectional conduction first pin 11402 is electrically connected to the transformer third pin 10810. The first unidirectional conduction second pin 11404 is electrically connected to the power output side 104.

The first electric charge storage unit 116 includes a first electric charge storage first pin 11602 and a first electric charge storage second pin 11604. The first electric charge storage first pin 11602 is electrically connected to the power output side 104. The first electric charge storage second pin 11604 is electrically connected to the transformer fourth pin 10812.

The second electric charge storage unit 118 includes a second electric charge storage first pin 11802 and a second electric charge storage second pin 11804. The second electric charge storage first pin 11802 is electrically connected to the transformer fourth pin 10812. The second electric charge storage second pin 11804 is electrically connected to the power negative side 106.

The second unidirectional conduction unit 120 includes a second unidirectional conduction first pin 12002 and a second unidirectional conduction second pin 12004. The second unidirectional conduction first pin 12002 is electrically connected to the transformer second pin 10808.

The mode change-over switch unit 122 includes a mode change-over switch first pin 12202, a mode change-over switch second pin 12204 and a mode change-over switch third pin 12206. The mode change-over switch first pin 12202 is electrically connected to the second unidirectional conduction second pin 12004. The mode change-over switch second pin 12204 is electrically connected to the mode change-over switch control unit 124. The mode change-over switch third pin 12206 is electrically connected to the transformer fourth pin 10812.

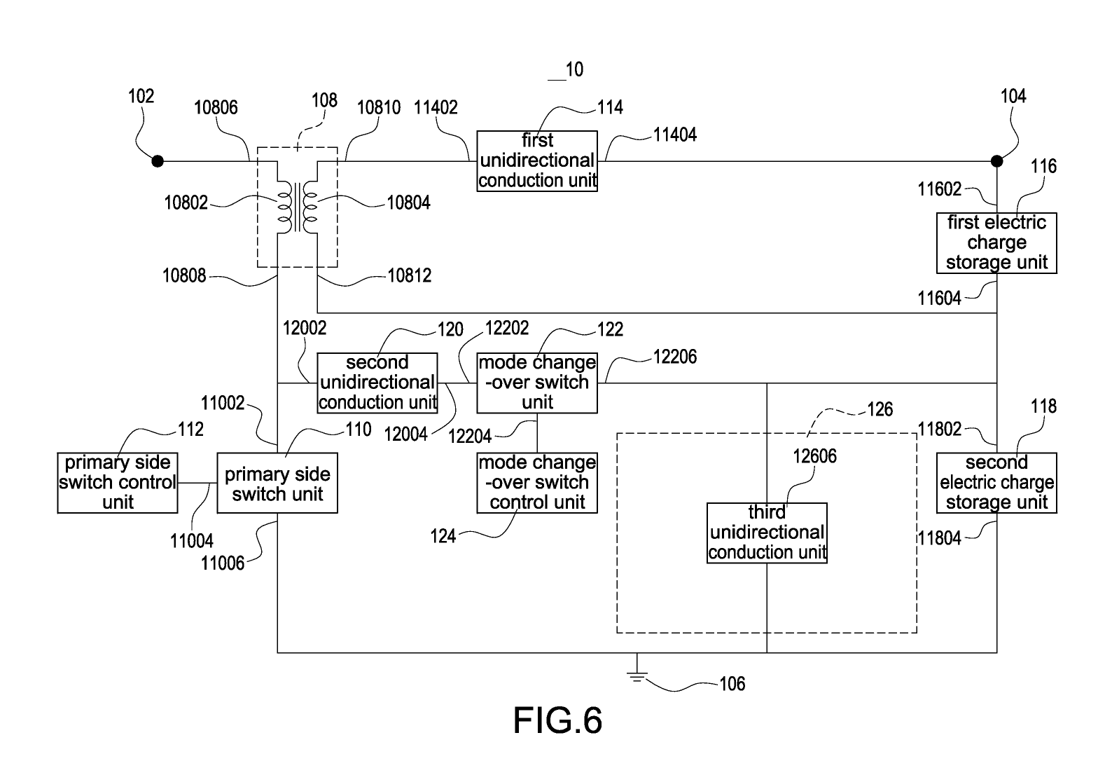

FIG. 6 shows a block diagram of the third embodiment of the reboost power conversion apparatus of the present invention. The description for the elements shown in FIG. 6, which are similar to those shown in FIG. 5, is not repeated here for brevity. The second electric charge storage bypass circuit 126 includes a third unidirectional conduction unit 12606. The third unidirectional conduction unit 12606 is electrically connected to the transformer 108, the first electric charge storage unit 116, the second electric charge storage unit 118, the mode change-over switch unit 122 and the power negative side 106. The third unidirectional conduction unit 12606 is, for example but not limited to, a diode, wherein a cathode of the diode is electrically connected to the transformer 108, the first electric charge storage unit 116, the second electric charge storage unit 118 and the mode change-over switch unit 122, wherein an anode of the diode is electrically connected to the power negative side 106.

The present invention includes following features:

1. The mode change-over switch control unit 124 is configured to turn on the mode change-over switch unit 122 when the absolute value of the output voltage is larger than the absolute value of the input voltage, so that the reboost power conversion apparatus 10 is a reboost power converter. The mode change-over switch control unit 124 informs the bypass switch control unit 12604. The bypass switch control unit 12604 is configured to turn off the bypass switch unit 12602.

2. The mode change-over switch control unit 124 is configured to turn off the mode change-over switch unit 122 when the absolute value of the output voltage is not larger than the absolute value of the input voltage, so that the reboost power conversion apparatus 10 is a flyback power converter. Therefore, the lowest output voltage of the reboost power conversion apparatus 10 is not clamped by the input voltage. The output voltage of the reboost power conversion apparatus 10 can be smaller than the input voltage. The lowest output voltage of the reboost power conversion apparatus 10 can be zero. Therefore, the reboost power conversion apparatus 10 can be applied to the power supply which outputs the alternating current power. The second electric charge storage unit 118 will discharge electricity to the power negative side 106 correctly according to the second electric charge storage bypass circuit 126.

The efficiency of the present invention is that the lowest output voltage of the reboost power conversion apparatus can be zero, so that the reboost power conversion apparatus can be applied to the power supply which outputs the alternating current power.

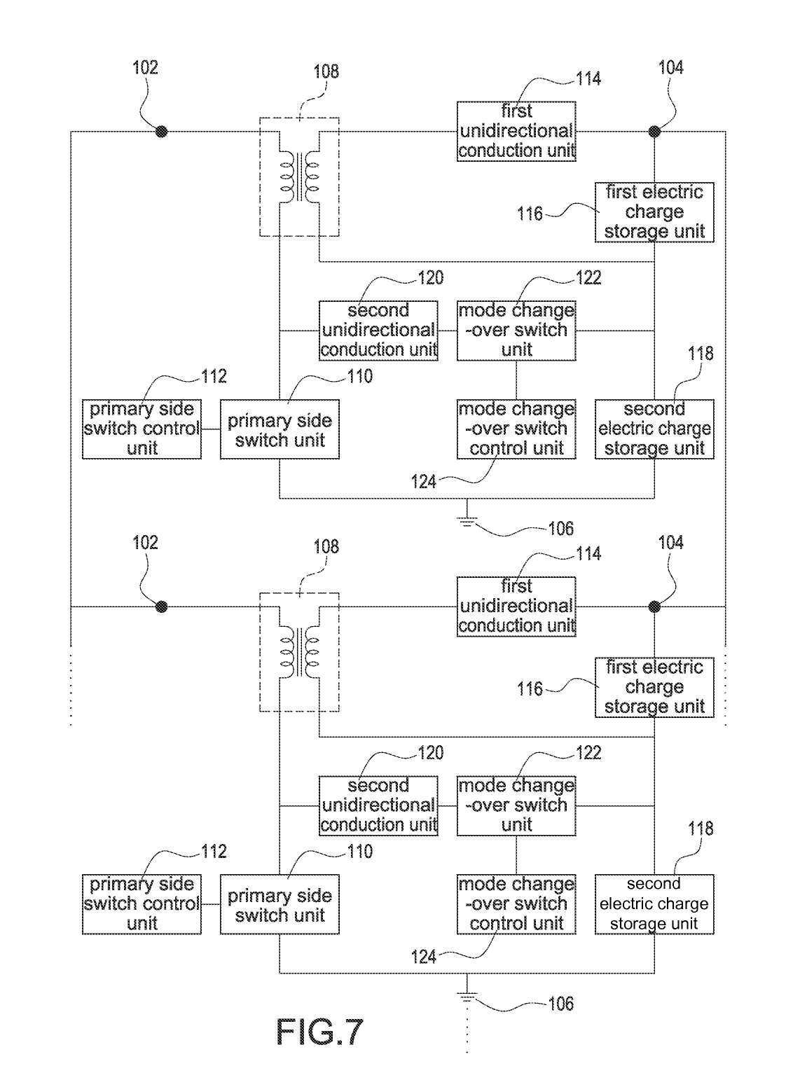

FIG. 7 shows a block diagram of the fourth embodiment of the reboost power conversion apparatus of the present invention. Moreover, in an embodiment, at least two of the reboost power conversion apparatuses 10 are electrically connected in parallel.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A reboost power conversion apparatus (10) having a flyback mode, the reboost power conversion apparatus (10) comprising:
a power input side (102);
a power output side (104);
a power negative side (106);
a transformer (108) electrically connected to the power input side (102);
a primary side switch unit (110) electrically connected to the transformer (108) and the power negative side (106);
a primary side switch control unit (112) electrically connected to the primary side switch unit (110);
a first unidirectional conduction unit (114) electrically connected to the transformer (108) and the power output side (104);
a first electric charge storage unit (116) electrically connected to the transformer (108) and the power output side (104);
a second electric charge storage unit (118) electrically connected to the transformer (108), the first electric charge storage unit (116) and the power negative side (106);
a second unidirectional conduction unit (120) electrically connected to the transformer (108) and the primary side switch unit (110);
a mode change-over switch unit (122) electrically connected to the second unidirectional conduction unit (120), the transformer (108), the first electric charge storage unit (116) and the second electric charge storage unit (118); and
a mode change-over switch control unit (124) electrically connected to the mode change-over switch unit (122),
wherein the reboost power conversion apparatus (10) has functions of a reboost power conversion apparatus when the mode change-over switch control unit (124) is configured to turn on the mode change-over switch unit (122); the reboost power conversion apparatus (10) has functions of a flyback power conversion apparatus when the mode change-over switch control unit (124) is configured to turn off the mode change-over switch unit (122).

2. The reboost power conversion apparatus (10) in claim 1, further comprising:
a second electric charge storage bypass circuit (126) electrically connected to the transformer (108), the first electric charge storage unit (116), the second electric charge storage unit (118), the mode change-over switch unit (122) and the power negative side (106),
wherein the second electric charge storage unit (118) discharges electricity to the power negative side (106) correctly according to the second electric charge storage bypass circuit (126) when the mode change-over switch control unit (124) is configured to turn off the mode change-over switch unit (122).

3. The reboost power conversion apparatus (10) in claim 2, wherein the second electric charge storage bypass circuit (126) comprises:
a bypass switch unit (12602) electrically connected to the transformer (108), the first electric charge storage unit (116), the second electric charge storage unit (118), the mode change-over switch unit (122) and the power negative side (106); and
a bypass switch control unit (12604) electrically connected to the bypass switch unit (12602) and the mode change-over switch control unit (124).

4. The reboost power conversion apparatus (10) in claim 3, wherein the transformer (108) comprises a transformer primary side (10802) and a transformer secondary side (10804); the transformer primary side (10802) is electrically connected to the power input side (102); the transformer secondary side (10804) is arranged in accordance with the transformer primary side (10802); the transformer primary side (10802) comprises a transformer first pin (10806) and a transformer second pin (10808); the transformer first pin (10806) is electrically connected to the power input side (102); the transformer secondary side (10804) comprises a transformer third pin (10810) and a transformer fourth pin (10812).

5. The reboost power conversion apparatus (10) in claim 4, wherein the primary side switch unit (110) comprises a primary side switch first pin (11002), a primary side switch second pin (11004) and a primary side switch third pin (11006); the primary side switch first pin (11002) is electrically connected to the transformer second pin (10808); the primary side switch second pin (11004) is electrically connected to the primary side switch control unit (112); the primary side switch third pin (11006) is electrically connected to the power negative side (106).

6. The reboost power conversion apparatus (10) in claim 5, wherein the first unidirectional conduction unit (114) comprises a first unidirectional conduction first pin (11402) and a first unidirectional conduction second pin (11404); the first unidirectional conduction first pin (11402) is electrically connected to the transformer third pin (10810); the first unidirectional conduction second pin (11404) is electrically connected to the power output side (104); the first electric charge storage unit (116) comprises a first electric charge storage first pin (11602) and a first electric charge storage second pin (11604); the first electric charge storage first pin (11602) is electrically connected to the power output side (104); the first electric charge storage second pin (11604) is electrically connected to the transformer fourth pin (10812); the second electric charge storage unit (118) comprises a second electric charge storage first pin (11802) and a second electric charge storage second pin (11804); the second electric charge storage first pin (11802) is electrically connected to the transformer fourth pin (10812); the second electric charge storage second pin (11804) is electrically connected to the power negative side (106); the second unidirectional conduction unit (120) comprises a second unidirectional conduction first pin (12002) and a second unidirectional conduction second pin (12004); the second unidirectional conduction first pin (12002) is electrically connected to the transformer second pin (10808).

7. The reboost power conversion apparatus (10) in claim 6, wherein the mode change-over switch unit (122) comprises a mode change-over switch first pin (12202), a mode change-over switch second pin (12204) and a mode change-over switch third pin (12206); the mode change-over switch first pin (12202) is electrically connected to the second unidirectional conduction second pin (12004); the mode change-over switch second pin (12204) is electrically connected to the mode change-over switch control unit (124); the mode change-over switch third pin (12206) is electrically connected to the transformer fourth pin (10812).

8. The reboost power conversion apparatus (10) in claim 7, wherein the reboost power conversion apparatus (10) is applied to a direct current to direct current area, a direct current to alternating current area, an alternating current to direct current area or an alternating current to alternating current area.

9. The reboost power conversion apparatus (10) in claim 8, wherein at least two of the reboost power conversion apparatuses (10) are electrically connected in parallel.

10. The reboost power conversion apparatus (10) in claim 2, wherein the second electric charge storage bypass circuit (126) comprises:
a third unidirectional conduction unit (12606) is electrically connected to the transformer (108), the first electric charge storage unit (116), the second electric charge storage unit (118), the mode change-over switch unit (122) and the power negative side (106).
